(19) United States
(12) Patent Application Publication
(10) Pub. No.: US 2008/0173292 A1
(43) Pub. Date: Jul. 24, 2008

(54) Cutting angle adjustment device for a stone cutter

(76) Inventors: Yuehting Chen, Fongyuan City (TW); Tsao Wen-Hai, Fongyuan City (TW)

Correspondence Address: Yuehting CHEN, P. O. Box 697, Fongyuan City, Taichung County, 420, omitted

(21) Appl. No.: 11/707,931

(22) Filed: Feb. 20, 2007

(30) Foreign Application Priority Data
Jan. 19, 2007 (TW) 096201050

(51) Int. Cl. B28D 1/04

(52) U.S. Cl. 125/13.03

(57) ABSTRACT

A cutting angle adjustment device for a stone cutter includes a rectangular water sink, an inverse L-shaped support arm anchored to a lateral side of the sink, a stone cutter adjustably connected to the support arm through a coupling assembly, a pair of guide rods parallel disposed to a pair of rack on front and rear ends of the sink, a platform having two alignments of rotors symmetrically arranged and slidably engaging with the inner sides of the pair of guide rods, a vertical cutting slit and a slant cutting slit parallel formed in the upper surface thereof. Thereby, a saw blade has been adjusted vertically and/or slantly relative to the top of the platform to conduct a vertical or slant cutting and a shallow or deep cutting of the working pieces.

### BACKGROUND OF THE INVENTION

The present invention relates to the cutters and more particularly to a cutting angle adjustment device for a stone cutter which is capable of vertical, slant, shallow and deep cutting of a working piece.

Conventional stone cutter has its blade perpendicular to the platform only straightly cutting the edge for a working piece. If want to cut a slant edge, the worker must cut a straight edge before put the working piece slantwise to cut a slant edge. Yet the angle of the slant edge is always not so acurate because of the manual adjustment. The worker has to trying and trying again but its difficult for a worker to decide a right angle so that the slant edge is inconsistently before and after, that is pot practical but wasting time.

The applicant of the present invention has been granted a R.O.C. utility model patent application No. 94207355, titled “Saw blade angular adjustment device for a metal and wood cutting machine” or the U.S. application patent Ser. No. 11/138,337. These patent are mainly used a pair of axle plates to cause a displacement seat to positioning to affect the cutting machine making a correct slant angle. Due to that this cutting machine is of small sized. It only has one cutting groove in a small platform which could not slide, so only capable of cutting small working pieces and no way to cut a large working piece.

The applicant has also been granted a R.O.C. utility model patent application No. 92221201, titled “Blade angle adjustment device for a stone cutter” or a U.S. Pat. No. 6,932,075 which has principally an axle arm to support a stone cutter which is capable of adjusting the slant angle on the axle arm to slantwise cut a working piece. Then platform is slidable and has a vertical and a slant cutting groove. When conduct a vertical cutting, the blade can deeply enter into the cutting groove. If want to conduct a slant cutting, the user has to slide away the platform for enabling the stone cutter to adjust a slant angle on the axle arm. The put the platform back to its original position in order to begin a slant cutting. The slant angle is always 45 degrees. There must be making errors if conducts shallow cutting. However, it is a bore job for the worker who always slides in and out of the platform for adjusting the slant angle.

### SUMMARY OF THE PRESENT INVENTION

The present invention has a main object to provide a cutting angle adjustment device for a stone cutter which is easily to adjust a slant angle for cutting a slant edge of the working piece.

Another object of the present invention is to provide a cutting angle adjustment device for a stone cutter which can conduct shallow or deep cuttings. The cutting angle, either vertical or slant is always acurate.

Accordingly the cutting angle adjustment device for a stone cutter comprises generally:

a water sink supported at front and rear ends by a pair racks, a pair of guide rods parallel disposed on the racks perpendicularly for sliding a platform thereon,

a support arm stand on the rack having a central hole and an arcuate slot on a top for connecting a coupling member which is centered in the central hole and adjusting the slant angle along the arcuate slot,

the coupling assembly has one end axially connected to the support arm and other end connected to the stone cutter, an adjustable plate pivoted to the top. The adjustable plate has one end connected to the top of the stone cutter and an adjustable hole,

the stone cutter including a motor, a saw blade and housing on outside,

the platform having two alignment of rollers on under-side slidably engaged with the guide rods, a vertical cutting groove and slant cutting groove parallel formed in the top,

thereby, the stone cutter enables to make longitudinal inclination upon the support arm and horizontal inclination upon the adjustable plate to conduct a shallow or a deep cutting in a certain angle.

The present invention will become more fully understood by reference to the following detailed description thereof when read in conjunction with the attached drawings.

### BRIEF DESCRIPTION OF THE DRAWINGS

FIG. 1 is an exploded perspective view of the preferred embodiment of the present invention,

FIG. 2 is a perspective view to show the assembly of FIG. 1,

FIG. 3 is a plane view to show that the stone cutter is risen up an angle of elevation,

FIG. 4 is a plane view looking from the right side of the stone cutter,

FIG. 5 is a plane view looking from the front side,

FIG. 6 is a plane view of FIG. 5 where the stone cutter is adjusted a slant angle,

FIG. 7 is a plate view looking from right side where the stone cutter is suspended in the air,

FIG. 8 is a plane view looking from the front side where the stone cutting is conducting a slant cutting, and

FIG. 9 is a plane view of FIG. 8 looking from the right side.

### DETAILED DESCRIPTION OF THE PREFERRED EMBODIMENT

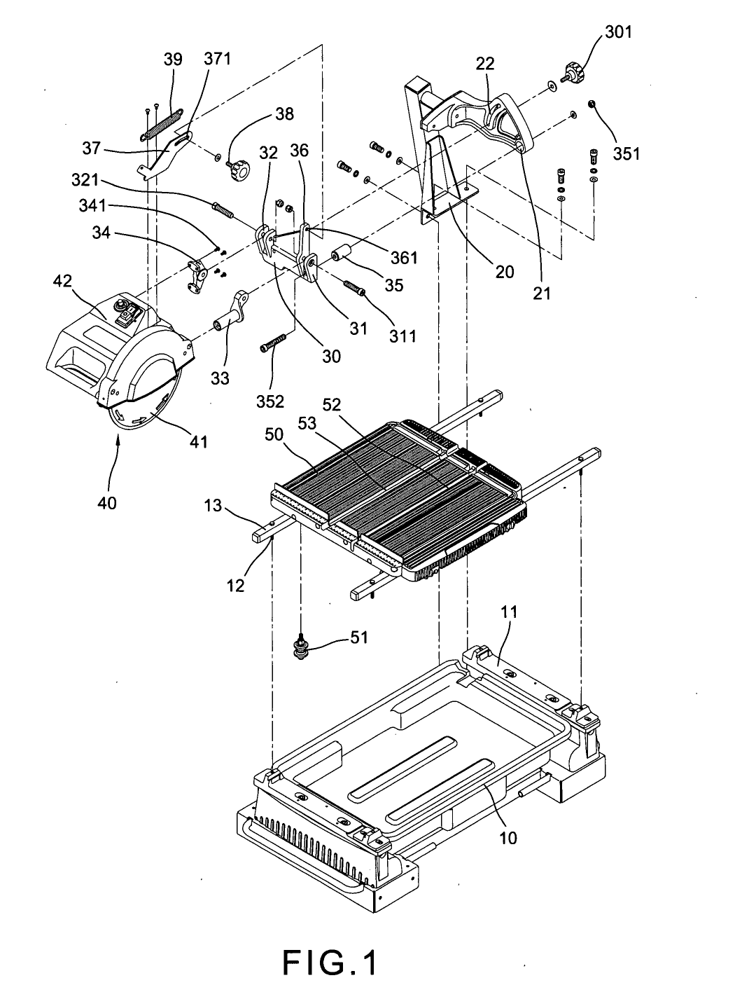

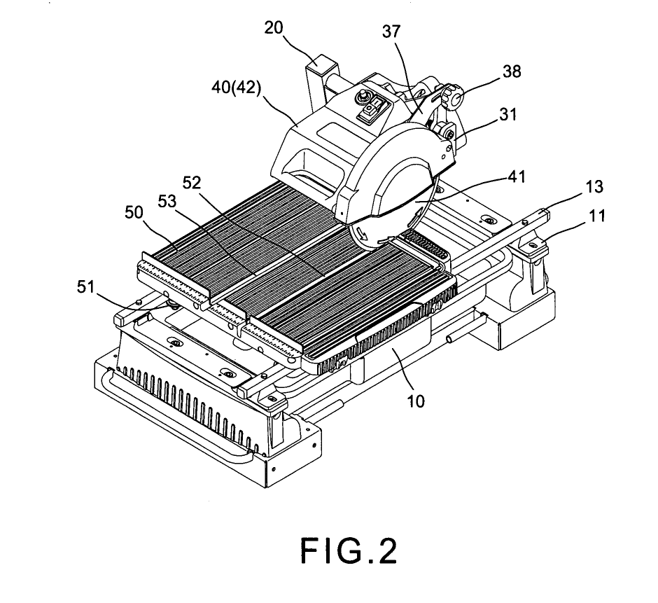

With reference to the drawings and initiated from FIGS. 1, 2 and 3, the cutting angle adjustment device for a stone cutter comprises generally a water sink 10, a support arm 20, a coupling assembly 30, a stone cutter 40 and a platform 50.

The water sink 10 is of a rectangular basin supported at front end and rear end by a pair of racks 11, the water inside the sink 10 is to mix the sawdust or that it keeps no water to directly collect the sawdust, a pair of guide rods parallel disposed upon the racks 11 and secured by screws 12.

The support arm 20 is secured to a lateral wall of the sink 10 abutting to the front end thereof and has an inverse L-shaped body, a central hole 21 (circular hole) in a triangular end of the transverse portion of the inverse L-shaped and a vertical arcuate slot 22 near by the central hole 21.

The coupling assembly 30 is disposed between the support arm 20 and the stone cutter 40 and has a U-shaped coupling means 31 and 32 at each end, wherein the U-shaped coupling means 31 has an upright projection 36 on inner side, an axle connection tube 33 having a protrusion on front end pivoted to the U-shaped coupling means 31 by bolt 311, the other end of the axle connection tube 33 connected to the housing 42 of the stone cutter 40, a positioning member 34 having a lower end pivoted to the U-shaped coupling means 32 by bolt 321 and an upper end connected to the housing 42 by screws 341, a central tube 35 connected between a screw hole in the lower portion of the U-shaped coupling means 31 and the central hole 21 of the support arm 20 by a bolt 352 and nut 351, the upright projection 36 has another screw hole 361 in an upper end facing to the support arm 20 (not shown) pivoted to a hand bolt 301 through the arcuate slot 22, an adjustable plate 37 having an transverse adjustable slot 371 engaged with the screw hole 361 of the upright projection and releasably secured by another hand bolt 38, the other end of the adjustable plate 37 connected to a top of the housing 42 of the stone cutter 40, a spring 39 having one end connected to the upright projection 36 and other end connected to the rear end of the adjustable plate 37 for providing the resilient force to the stone cutter 40.

The stone cutter 40 includes a disc saw 41, a housing 42 and a motor (not shown) inside the housing 42.

The platform 50 has a rectangular body, two alignment of rotors 51 symmetrically arranged on underside and rotatably sliding on the inner sides of the guide rods 13, a vertical cutting slit 52 and a slant cutting slit 53 parallel formed in the upper surface.

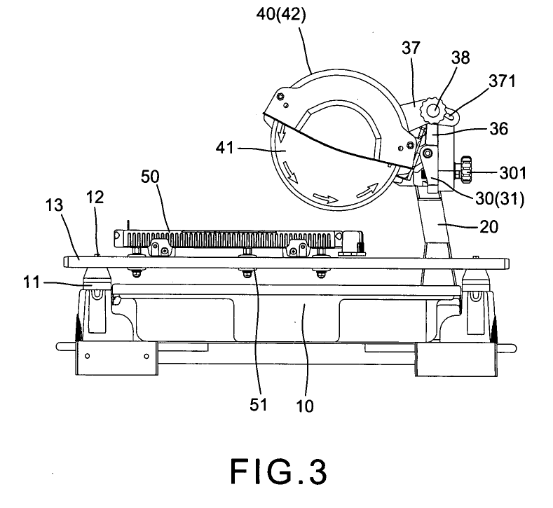

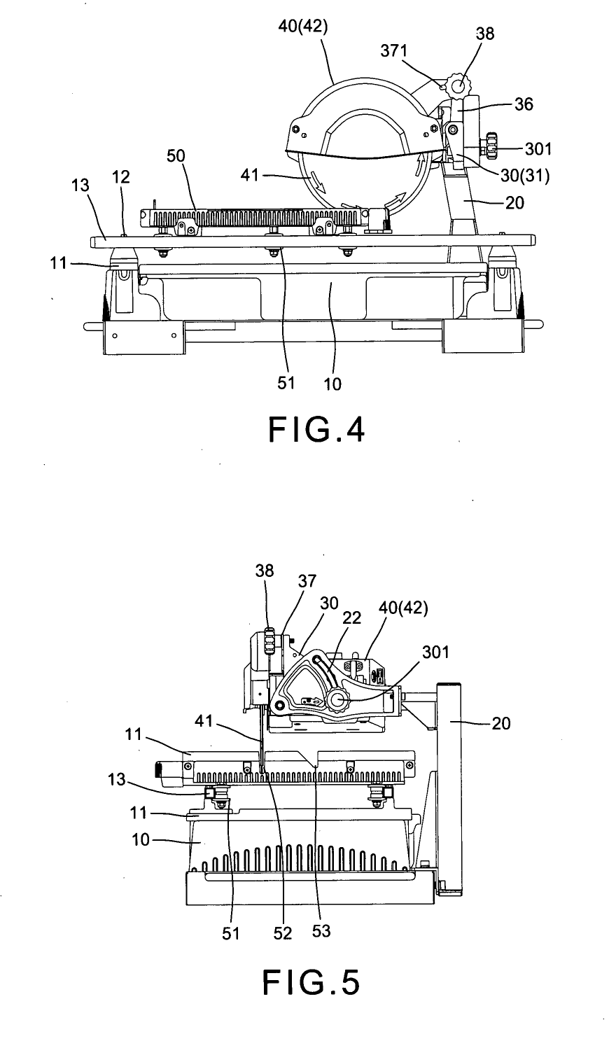

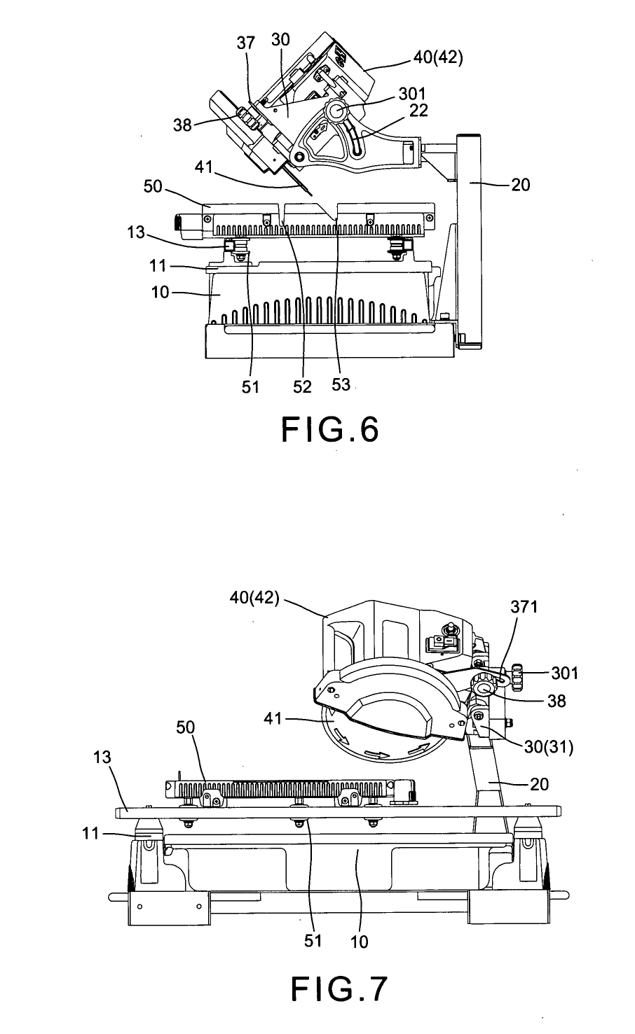

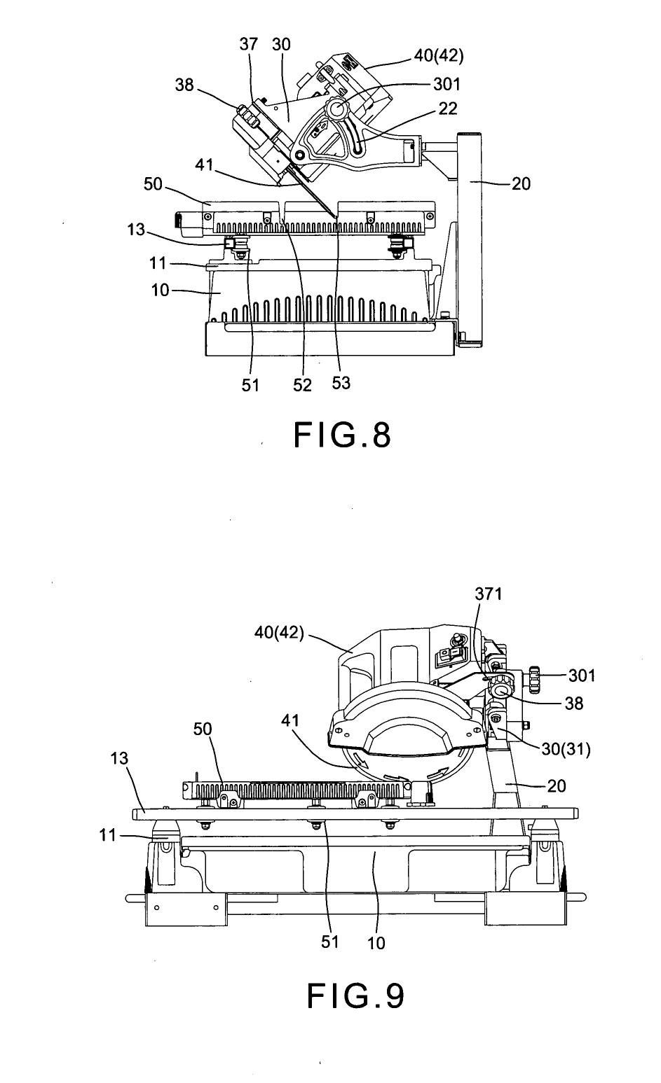

Referring to FIGS. 3, 4 and 5, before conducting a vertical cutting, first loosens the hand bolt 38 to release the adjustable plate 37 until the hand bolt 38 sliding to the front end of the slot 371, then fastens the hand bolt 38 to fix the adjustable plate 37 for any longitudinal movement, the blade 41 of the stone cutter 40 automatically inserts into the vertical cutting slit 52. Then slides the platform 50 to meet the downward movement of the stone cutter 40 until that the saw blade 41 engaged into the vertical cutting groove 51, the adjustment is completed. And then starts the motor beginning to cut a working piece. When conducts a slant cutting, loosens the hand bolt 301 and slide it within the arcuate slot 22 entered on the central hole 21 to slant the coupling assembly 30. Fastens the hand bolt 301 till it reaches to the top of the arcuate slot 22. While the slant angle of the saw blade 41 is exactly 45 degrees relative to the upper surface of the platform 50 and enters into the slant cutting groove 53, the adjustment for slant cutting is finished.

The stone cutter can also conduct a shallow cutting. That is positioning the hand bolt 38 at a middle portion of the slot 371 of the adjustable plate 37 so that the saw blade 41 will not deeply enter into the slant cutting groove 53 but still keeps 45 degrees of slant angle. This time, the user can conduct a shallow cutting of the working pieces.

The present invention discards the disadvantages of the prior art such as the single cutting groove or changing the slant angle when conducts a shallow cutting. But the present invention, no matter conducting a shallow or deep cutting the slant angle deeps unchanged. The angle adjustment is to be carried out even if that the platform 50 is not moved off. So it is very convenient.

Note that the specification relating to the above embodiment should be construed as an exemplary rather than as a limitative of the present invention, with many variations and modifications being readily attainable by a person of average skill in the art without departing from the spirit or scope thereof as defined by the appended claims and their legal equivalents.

1. A cutting angle adjustment device for stone cutter comprising:
a water sink which is a rectangular basin having a front and rear ends supported by a pair of racks;
a pair of guide rods parallel disposed on the racks and secured by screws;
an inverse L-shaped support arm secured to a lateral wall of the sink abutting to the front end thereof, a circular central hole in a triangular of a transverse portion of the inverse L-shaped support and a vertical arcuate slot nearby the central hole;
a stone cutter having a housing, a motor in the housing and a saw blade under the housing;
a coupling assembly disposed between said support arm and said stone cutter having a first and second U-shaped coupling means on two ends thereof wherein the first U-shaped coupling means has an upright projection tube having a front end pivotally connected to the first U-shaped coupling means by a bolt, the axle connection tube having another end connected to the housing of said stone cutter, a positioning member having a lower end pivotally connected to the second U-shaped coupling means by bolt and an upper end connected to the housing by screws, a central tube connected between a screw hole in a lower portion of first U-shaped coupling means and the central hole of said support arm by a bolt and nut; said upright projection having another screw hole in an upper end pivotally connected to a first hand bolt through the vertical acruate slot of said support arm, an adjustable plate having a transverse adjustable slot engaged with a screw hole of the upright projection releasbly secured by a second hand bolt, the adjustable plate having connected to a top of said housing, a spring having front end connected to the upright projection and another end connected to a rear end of said adjustable plate;
a platform having rectangular body slidably disposed on the pair of guide rods, two alignment of rotors symmetrically arranged on underside thereof rotatably sliding on inner sides of the guide rods, a vertical cutting slit and a slant cutting slit parallel formed in upper surface of the platform;
whereby, can adjust vertical position and the slant angle for the stone cutter to conduct a vertical and slant cutting.

2. The cutting angle adjustment device as recited in claim 1, wherein said stone cutter is able to conduct a shallow and deep cutting after an adjustment to the vertical position of the saw blade.
